(19) United States
(12) Patent Application Publication
(10) Pub. No.: US 2018/0123749 A1
(43) Pub. Date: May 3, 2018

(54) WAVEFORM FOR INTERNET-OF-THINGS DATA TRANSFER

(71) Applicant: Intel Corporation, Santa Clara, CA (US)

(72) Inventors: Shahrnaz Azizi, Cupertino, CA (US); Hosein Nikopour, San Jose, CA (US); Thomas J. Kenney, Portland, OR (US)

(21) Appl. No.: 15/607,149

(22) Filed: May 26, 2017

Related U.S. Application Data
(60) Provisional application No. 62/416,969, filed on Nov. 3, 2016.

(51) Int. Cl. H04L 5/00

(52) U.S. Cl. CPC H04L 5/0007; H04L 67/12

(57) ABSTRACT

Described herein are waveform designs and systems that enable low-power narrow bandwidth operations by battery powered Internet-of-Things devices in an 802.11ax environment. In one embodiment, a single carrier waveform is frequency multiplexed within 802.11ax OFDM transmissions in both the downlink and uplink. The single-carrier waveform provides a low peak-to-average-power-ratio to lower the overall power consumption of the battery powered devices.

### PRIORITY CLAIM

This application claims priority to U.S. Provisional Patent Application Ser. No. 62/416,969 filed, Nov. 3, 2016, which is incorporated herein by reference in its entirety

### TECHNICAL FIELD

Embodiments described herein relate generally to wireless networks and communications systems.

### BACKGROUND

Wireless networks as defined by the IEEE 802.11 specifications (sometimes referred to as Wi-Fi) are currently being advanced to provide much greater average throughput per user to serve future communications needs. The IEEE 802.11ax standard as presently proposed incorporates features that include, for example, downlink and uplink multi-user (MU) operation by means of orthogonal frequency division multiple access (OFDMA) and multi-user multiple-input-multiple-output (MU-MIMO) technologies.

There has been considerable interest in applying Wi-Fi technology to Internet-of-Things applications. IoT devices are typically battery powered and require low-power operation. A concern of the present disclosure is a waveform design that can be used by IoT devices in an 802.11ax environment.

### BRIEF DESCRIPTION OF THE DRAWINGS

FIG. 1 is a block diagram of a radio architecture in accordance with some embodiments.

FIG. 2 illustrates a front-end module circuitry for use in the radio architecture of FIG. 1 in accordance with some embodiments.

FIG. 3 illustrates a radio IC circuitry for use in the radio architecture of FIG. 1 in accordance with some embodiments.

FIG. 4 illustrates a baseband processing circuitry for use in the radio architecture of FIG. 1 in accordance with some embodiments.

FIG. 5 illustrates an example of a computing machine according to some embodiments.

FIG. 6 illustrates an example of a wireless station device according to some embodiments.

FIG. 7 illustrates a basic service set that includes stations and a low power station associated with an access point according to some embodiments.

FIG. 8 illustrates components for transmitting data to stations via orthogonal frequency division multiplexing and to low power stations via a single carrier waveform according to some embodiments.

FIG. 9 illustrates components for transmitting data to stations via orthogonal frequency division multiplexing and to low power stations via a single carrier waveform according to some embodiments.

FIG. 10 illustrates components for receiving data from stations via orthogonal frequency division multiplexing and from low power stations via a single carrier waveform according to some embodiments.

FIG. 11 shows a low power single carrier signal multiplexed within a central 802.11ax allocation according to some embodiments.

FIG. 12 shows multiple low power single carrier signals multiplexed within non-central 802.11ax allocations according to some embodiments.

### DETAILED DESCRIPTION

A main use case for optimizing Wi-Fi for IoT applications is the enabling of battery operated sensors and devices in applications such as smart home management, smart building management, industrial automation, and environmental sensing. For example, a Wi-Fi transceiver can be built into a temperature sensor in a HVAC duct, which cannot be reached easily, and hence requires possibly five years of battery life. Besides battery life, the sensor and IoT devices have to be low cost. One approach to reduce cost from current Wi-Fi devices as well as lowering power consumption is to create a new narrow bandwidth operational mode. Described herein are waveform designs and systems that provide such low-power (LP) narrow bandwidth (NB) operations.

### Example Radio Architecture

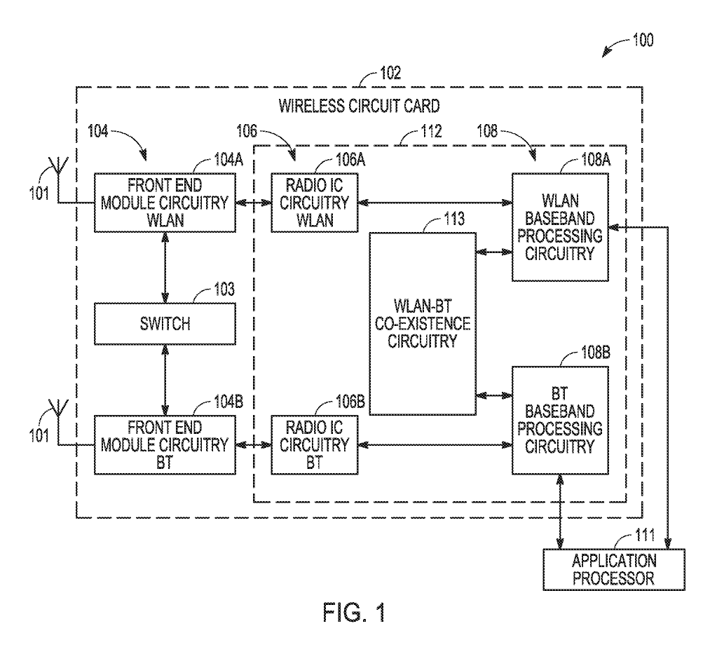

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104B may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 102, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106a may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 110 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, 802.11n-2009, IEEE 802.11-2012, 802.11n-2009, 802.11 ac, and/or 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

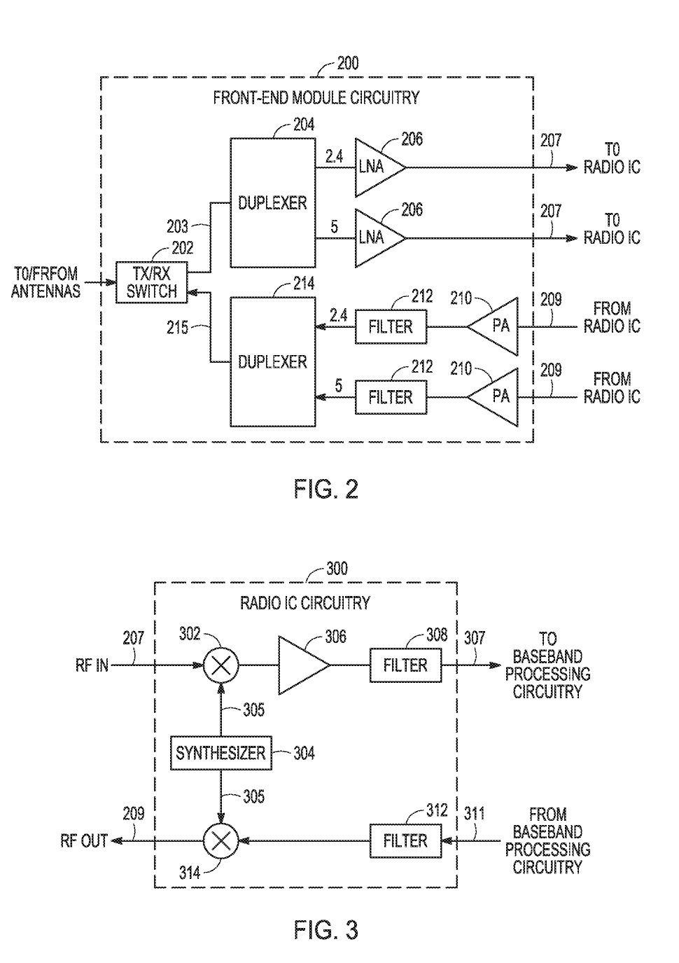

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 110 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 110.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

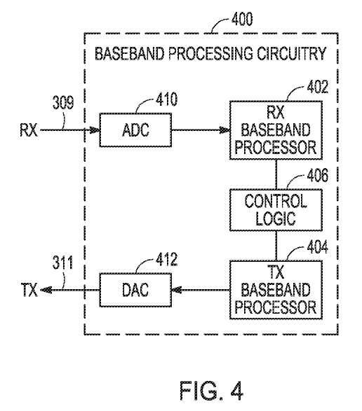

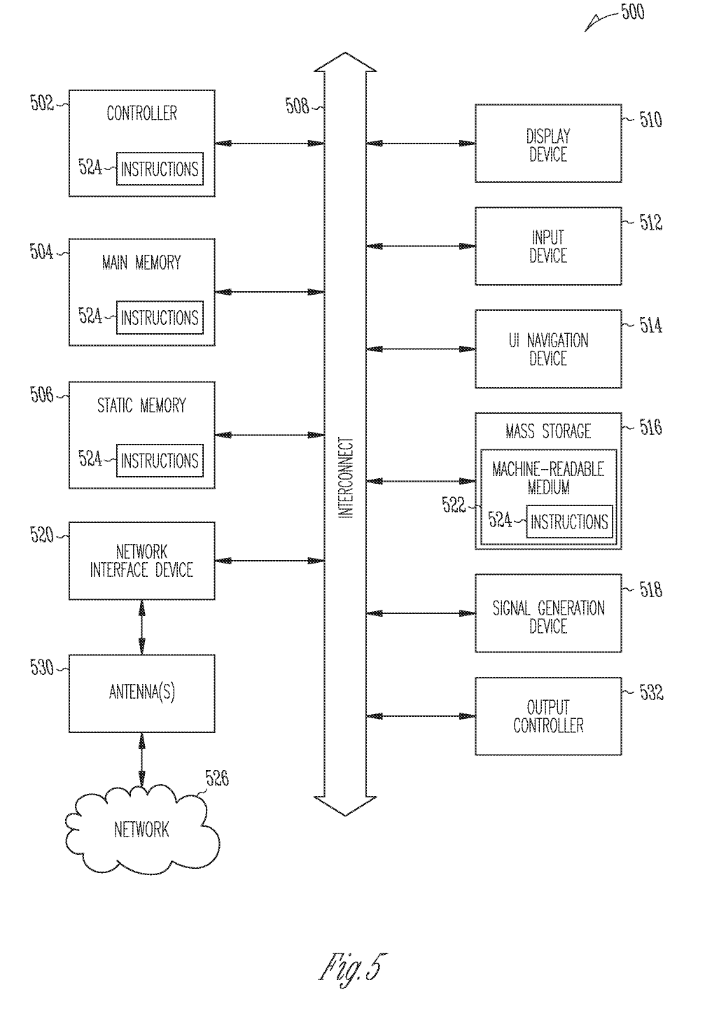

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108a, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

### Example Machine Description

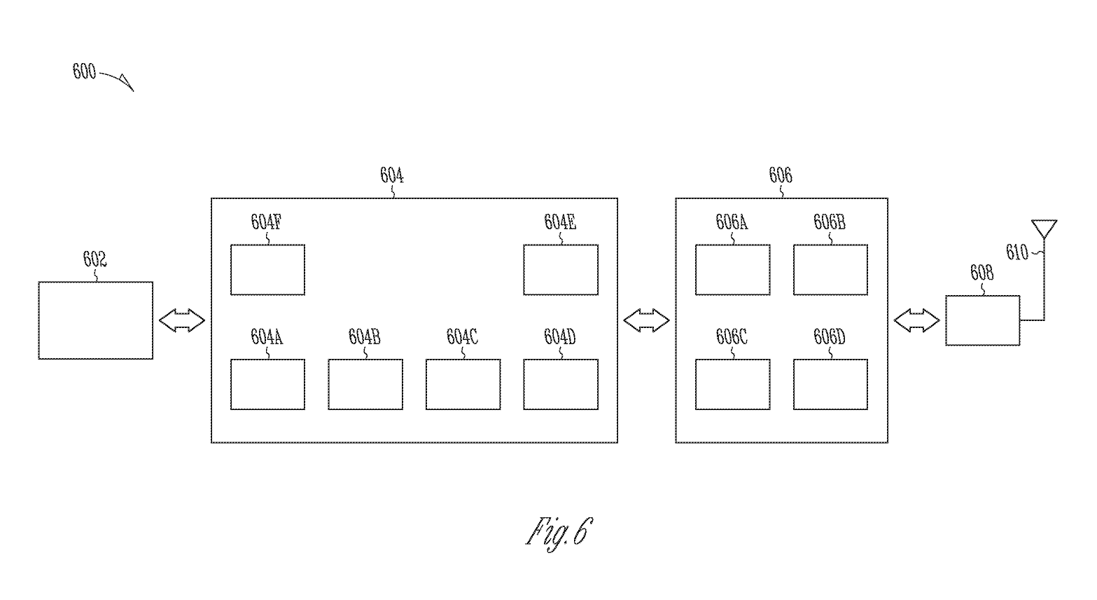

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a user equipment (UE), evolved Node B (eNB), Wi-Fi access point (AP), Wi-Fi station (STA), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding, or carrying instructions for execution by the machine 500, and includes digital or analog communications signals or other intangible medium to facilitate communication of such software.

### Example STA Description

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

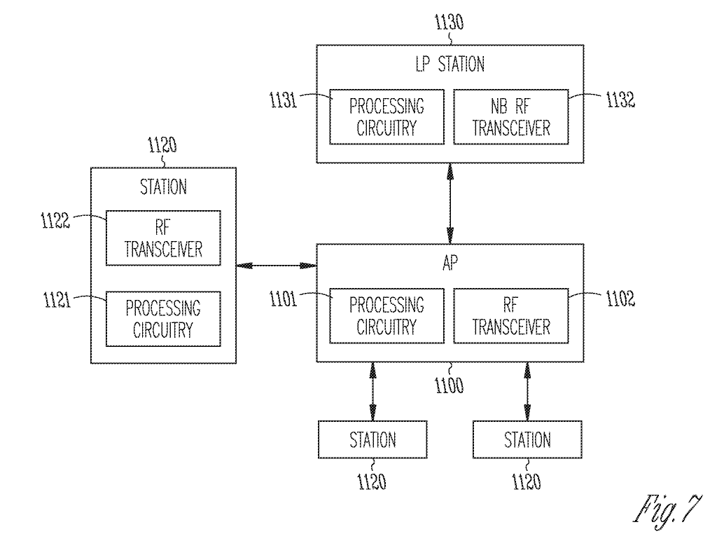

Embodiments described herein may be implemented into a system using any suitably configured hardware and/or software. FIG. 6 illustrates, for one embodiment, example components of a STA or User Equipment (UE) device 600. In some embodiments, the STA device 600 may include application circuitry 602, baseband circuitry 604, Radio Frequency (RF) circuitry 606, front-end module (FEM) circuitry 608 and one or more antennas 610, coupled together at least as shown.

The application circuitry 602 may include one or more application processors. For example, the application circuitry 602 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 604 may include circuitry such as, but not limited to, one or more single-core or multi-core processors. The baseband circuitry 604 may include one or more baseband processors and/or control logic to process baseband signals received from a receive signal path of the RF circuitry 606 and to generate baseband signals for a transmit signal path of the RF circuitry 606. Baseband processing circuity 604 may interface with the application circuitry 602 for generation and processing of the baseband signals and for controlling operations of the RF circuitry 606. For example, in some embodiments, the baseband circuitry 604 may include a second generation (2G) baseband processor 604a, third generation (3G) baseband processor 604b, fourth generation (4G) baseband processor 604c, and/or other baseband processor(s) 604d for other existing generations, generations in development or to be developed in the future (e.g., fifth generation (5G), 6G, etc.). The baseband circuitry 604 (e.g., one or more of baseband processors 604a-d) may handle various radio control functions that enable communication with one or more radio networks via the RF circuitry 606. The radio control functions may include, but are not limited to, signal modulation/demodulation, encoding/decoding, radio frequency shifting, etc. In some embodiments, modulation/demodulation circuitry of the baseband circuitry 604 may include Fast-Fourier Transform (FFT), precoding, and/or constellation mapping/demapping functionality. In some embodiments, encoding/decoding circuitry of the baseband circuitry 604 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 604 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 604e of the baseband circuitry 604 may be configured to run elements of the protocol stack for signaling of the PHY, MAC, RLC, PDCP and/or RRC layers. In some embodiments, the baseband circuitry may include one or more audio digital signal processor(s) (DSP) 604f. The audio DSP(s) 604f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 604 and the application circuitry 602 may be implemented together such as, for example, on a system on a chip (SOC).

In some embodiments, the baseband circuitry 604 may provide for communication compatible with one or more radio technologies. For example, in some embodiments, the baseband circuitry 604 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 604 is configured to support radio communications of more than one wireless protocol may be referred to as multi-mode baseband circuitry.

RF circuitry 606 may enable communication with wireless networks using modulated electromagnetic radiation through a non-solid medium. In various embodiments, the RF circuitry 606 may include switches, filters, amplifiers, etc. to facilitate the communication with the wireless network. RF circuitry 606 may include a receive signal path which may include circuitry to down-convert RF signals received from the FEM circuitry 608 and provide baseband signals to the baseband circuitry 604. RF circuitry 606 may also include a transmit signal path which may include circuitry to up-convert baseband signals provided by the baseband circuitry 604 and provide RF output signals to the FEM circuitry 608 for transmission.

In some embodiments, the RF circuitry 606 may include a receive signal path and a transmit signal path. The receive signal path of the RF circuitry 606 may include mixer circuitry 606a, amplifier circuitry 606b and filter circuitry 606c. The transmit signal path of the RF circuitry 606 may include filter circuitry 606c and mixer circuitry 606a. RF circuitry 606 may also include synthesizer circuitry 606d for synthesizing a frequency for use by the mixer circuitry 606a of the receive signal path and the transmit signal path. In some embodiments, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 604 for further processing. In some embodiments, the output baseband signals may be zero-frequency baseband signals, although this is not a requirement. In some embodiments, mixer circuitry 606a of the receive signal path may comprise passive mixers, although the scope of the embodiments is not limited in this respect.

In some embodiments, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 604 and may be filtered by filter circuitry 606c. The filter circuitry 606c may include a low-pass filter (LPF), although the scope of the embodiments is not limited in this respect.

In some embodiments, the mixer circuitry 606a of the receive signal path and the mixer circuitry 606a of the transmit signal path may include two or more mixers and may be arranged for quadrature downconversion and/or upconversion respectively. In some embodiments, the mixer circuitry 606a of the receive signal path and the mixer circuitry 606a of the transmit signal path may include two or more mixers and may be arranged for image rejection (e.g., Hartley image rejection). In some embodiments, the mixer circuitry 606a of the receive signal path and the mixer circuitry 606a may be arranged for direct downconversion and/or direct upconversion, respectively. In some embodiments, the mixer circuitry 606a of the receive signal path and the mixer circuitry 606a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 606 may include analog-to-digital converter (ADC) and digital-to-analog converter (DAC) circuitry and the baseband circuitry 604 may include a digital baseband interface to communicate with the RF circuitry 606.

In some dual-mode embodiments, a separate radio IC circuitry may be provided for processing signals for each spectrum, although the scope of the embodiments is not limited in this respect.

In some embodiments, the synthesizer circuitry 606d may be a fractional-N synthesizer or a fractional N/N+1 synthesizer, although the scope of the embodiments is not limited in this respect as other types of frequency synthesizers may be suitable. For example, synthesizer circuitry 606d may be a delta-sigma synthesizer, a frequency multiplier, or a synthesizer comprising a phase-locked loop with a frequency divider.

The synthesizer circuitry 606d may be configured to synthesize an output frequency for use by the mixer circuitry 606a of the RF circuitry 606 based on a frequency input and a divider control input. In some embodiments, the synthesizer circuitry 606d may be a fractional N/N+1 synthesizer.

In some embodiments, frequency input may be provided by a voltage controlled oscillator (VCO), although that is not a requirement. Divider control input may be provided by either the baseband circuitry 604 or the applications processor 602 depending on the desired output frequency. In some embodiments, a divider control input (e.g., N) may be determined from a look-up table based on a channel indicated by the applications processor 602.

Synthesizer circuitry 606d of the RF circuitry 606 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 606d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 606 may include an IQ/polar converter.

FEM circuitry 608 may include a receive signal path which may include circuitry configured to operate on RF signals received from one or more antennas 610, amplify the received signals and provide the amplified versions of the received signals to the RF circuitry 606 for further processing. FEM circuitry 608 may also include a transmit signal path which may include circuitry configured to amplify signals for transmission provided by the RF circuitry 606 for transmission by one or more of the one or more antennas 610.

In some embodiments, the FEM circuitry 608 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission (e.g., by one or more of the one or more antennas 610.

In some embodiments, the UE device 600 may include additional elements such as, for example, memory/storage, display, camera, sensor, and/or input/output (I/O) interface.

### Description of Embodiments

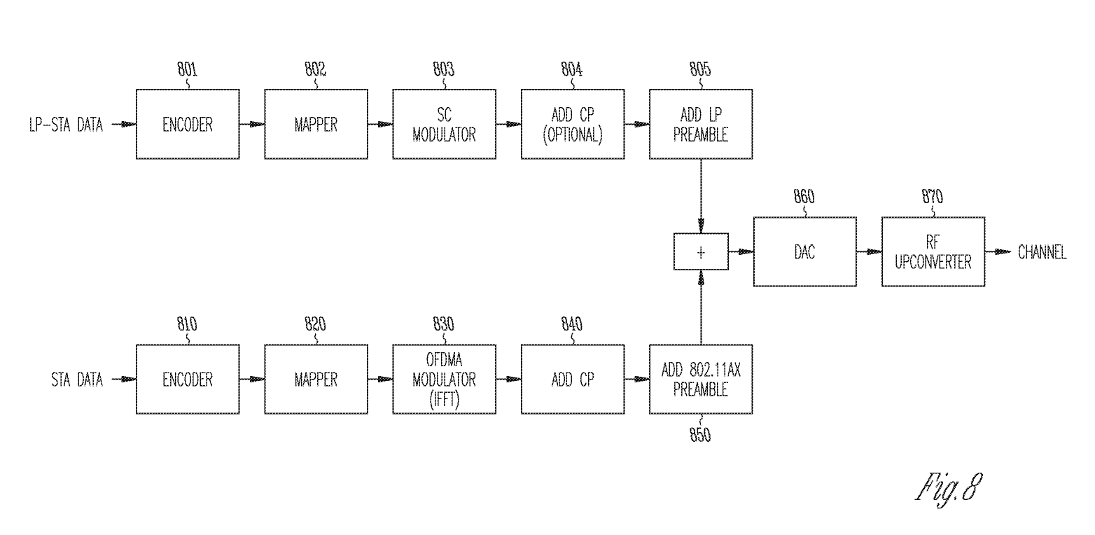

In an 802.11 local area network (LAN), the entities that wirelessly communicate are referred to as stations (STAs). A basic service set (BSS) refers to a plurality of stations that remain within a certain coverage area and form some sort of association. In one form of association, the stations communicate directly with one another in an ad-hoc network. More typically, however, the stations associate with a central station dedicated to managing the BSS and referred to as an access point (AP). FIG. 7 illustrates a BSS that includes station devices 1120 associated with an access point (AP) 1100. The devices 1120 may be any type of device with functionality for connecting to a WiFi network such as a computer, smart phone, or a UE (user equipment) with WLAN access capability, the latter referring to terminals in a LTE (Long Term Evolution) network. Each of the STAs include an RF (radio frequency transceiver) 1122 and processing circuitry 1121, and the AP includes an RF (radio frequency transceiver) 1102 and processing circuitry 1101. The processing circuitry includes the functionalities for WiFi network access via the RF transceiver as well as functionalities for processing as described herein. The RF transceivers of the STAs 1120 and access point 1100 may each incorporate one or more antennas. The RF transceiver 1100 with multiple antennas and processing circuitry 1101 may implement one or more MIMO (multi-input multi-output) techniques such as spatial multiplexing, transmit/receive diversity, and beam forming. The devices 1100 and 1120 are representative of the wireless access points and stations described below.

FIG. 7 also shows a low-power station (LP-STA) 1130 (e.g., an IoT device as described above) associated with the AP 1100. The LP-STA 1130 includes processing circuitry 1131 and a narrowband (NB) RF transceiver 1132. As will be discussed below, the NB RF transceiver 1132 is used to transmit and receive a single carrier waveform that is frequency multiplexed with signals from the other STAs in the BSS.

The 802.11ax standard provides for downlink (DL) and uplink (UL) multi-user (MU) operation. Multiple simultaneous transmissions to different STAs from the AP in the DL and from multiple STAs to the AP in the UL are enabled via MU-MIMO and/or orthogonal frequency division multiple access (OFDMA). The 802.11ax physical (PHY) layer is mainly inherited from previous 802.11 standards and supports operation in 20 MHz, 40 MHz, 80 MHz, 80+80 MHz and 160 MHz bandwidth channels. The OFDM symbol duration is specified as 12.8 us, and the guard interval (GI) between OFDM symbols may be selected as either 0.8 us, 1.6 us or 3.2 us. With MU-MIMO, multiple antenna beamforming techniques are used to form spatial streams (SSs) that the AP assigns to STAs for UL and DL transmissions. With OFDMA, the AP assigns separate subsets of OFDMA subcarriers (aka tones), referred to as resource units (RUs), to individual STAs for UL and DL transmissions. The size of an RU may be selected from several values specified by the standard with the smallest allocation being 26 tones. An entire 20 MHz channel bandwidth, for example, could be occupied by nine 26-tone RUs.

In an 802.11 WLAN network, the stations communicate via a layered protocol that includes the PHY layer and a medium access control (MAC) layer. The MAC layer is a set of rules that determine how to access the medium in order to send and receive data, and the details of transmission and reception are left to the PHY layer. At the MAC layer, transmissions in an 802.11 network are in the form of MAC frames of which there are three main types: data frames, control frames, and management frames. In 802.11ax systems, a type of MAC control frame referred to as a trigger frame is used by the AP to elicit responses from multiple STAs, where the trigger frame carries RU allocations for the STAs to use for their uplink transmissions.

MAC frames, which include the data payload, are carried by PHY layer packets that start with a preamble. The 802.11ax standard specifies that an 802.11ax preamble includes a legacy preamble and a high-efficiency (HE) preamble. The legacy and HE preambles span 20 MHz of bandwidth, and they are duplicated for each 20 MHz of the total system bandwidth. The 802.11ax preamble includes fields needed for synchronization, automatic gain control (AGC), and other functions related to packet reception and processing. For downlink transmissions to STAs from the AP, the 802.11ax preamble also has a field that indicates the RU allocations for the STAs to which data is to be transmitted.

For present 802.11ax OFDMA modes, even when a device transmits a narrowband signal within one RU, it is required to first transmit the legacy preamble at 20 MHz. In addition, transmission within one RU is OFDMA, and OFDMA has a relatively high Peak to Average Power Ratio (PAPR) when compared to single carrier waveforms. Transmission of the legacy portion of the preamble in 802.11ax affords coexistence with legacy devices, and OFDMA provides orthogonality among different users assigned to different RUs. While these provide certain advantages for an 802.11ax design, they drastically limit the power savings that can achieved. Thus, mechanisms to allow future LP devices to have good power amplifier efficiency and to coexist with legacy devices are needed.

To address the power consumption issue, the use of a single carrier (SC) waveform is proposed. An SC waveform has a very low PAPR affording the use of a very efficient power amplifier (PA) in IoT devices. PA efficiency is one the most important measures in power consumption during a transmit cycle. The basic principle is to frequency multiplex a single carrier waveform within the 802.11ax OFDMA transmission in both the downlink (DL) and uplink (UL). The SC waveform provides low PAPR, which in turn improves the PA efficiency and hence overall power consumption of an IoT device. The proposed single carrier waveform is different from the legacy 802.11b mode because it operates within an 802.11ax network and has a narrow bandwidth of operation. One focus of this disclosure is to define a system and frame structure where 802.11ax users are scheduled along with these LP devices in Wi-Fi networks.

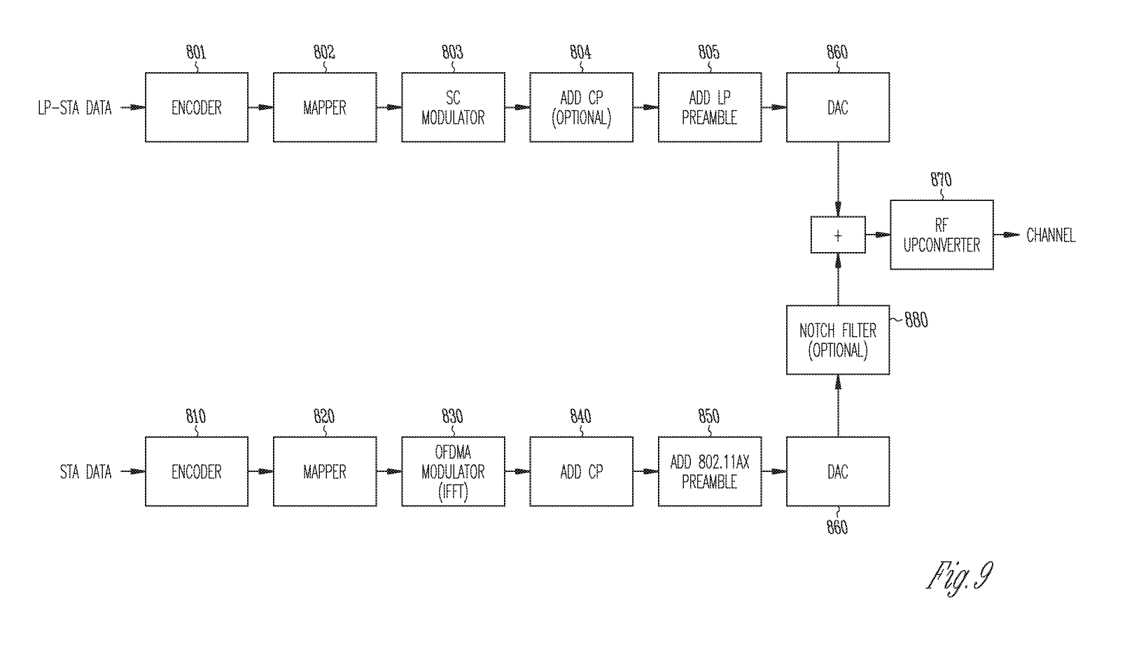

FIGS. 8 through 10 illustrate baseband processing circuitry components for transmitting and receiving both 802.11ax OFDMA and SC waveforms according to some embodiments. The components may be incorporated into a STA in order for it to communicate with regular STAs via OFDMA and with LP-STAs via SC waveforms. The components may be incorporated into APs or into non-AP STAs to form hybrid devices capable of both narrowband SC and wideband OFDMA operation. Such hybrid devices may be operated, for example, as assisting stations whose function is to facilitate communications between an AP and LP-STAs.

FIG. 8 illustrates components for transmitting data to STAs via OFDMA and to LP-STAs via the SC waveform according to one embodiment. LP-STA data is encoded with a forward error correction code by encoder 801, mapped to modulation symbols (e.g., BPSK or QAM) by mapper 802, mixed with a single carrier frequency by SC modulator 803 to form the digital SC waveform, prepended with a cyclic prefix (CP) by module 804, and prepended with an LP preamble by module 805. The CP addition is optional for the SC waveform as the narrowband channel may not be so time-dispersive as to need it. STA data is encoded with a forward error correction code by encoder 810, mapped to modulation symbols (e.g., BPSK or QAM) by mapper 820, converted to OFDM symbols by OFDMA modulator 830 (e.g., a serial-to-parallel converter and an inverse fast Fourier transform (IFFT) module) to form the digital OFDMA waveform, prepended with a cyclic prefix (CP) by module 840, and prepended with an 802.11ax preamble by module 850. The SC and OFDMA waveforms are then added to form a composite baseband waveform, converted to analog by ADC 860, and upconverted to RF by upconverter 870 for transmission over the wireless channel. The bandwidth of SC waveform may be made to correspond to one or more RUs within the OFDMA waveform. Those subcarriers of the OFDMA waveform that are within a specified bandwidth on either side of the baseband carrier frequency of the SC waveform may be nulled by the OFDMA modulator 830. Also, the bandwidth of the LP preamble may be made much less than the minimum 20 MHz bandwidth of the 802.11ax preamble. In some embodiments, the bandwidth of the LP preamble may be made less than or equal to the rest of the SC waveform (i.e, the data field carrying the modulation symbols).

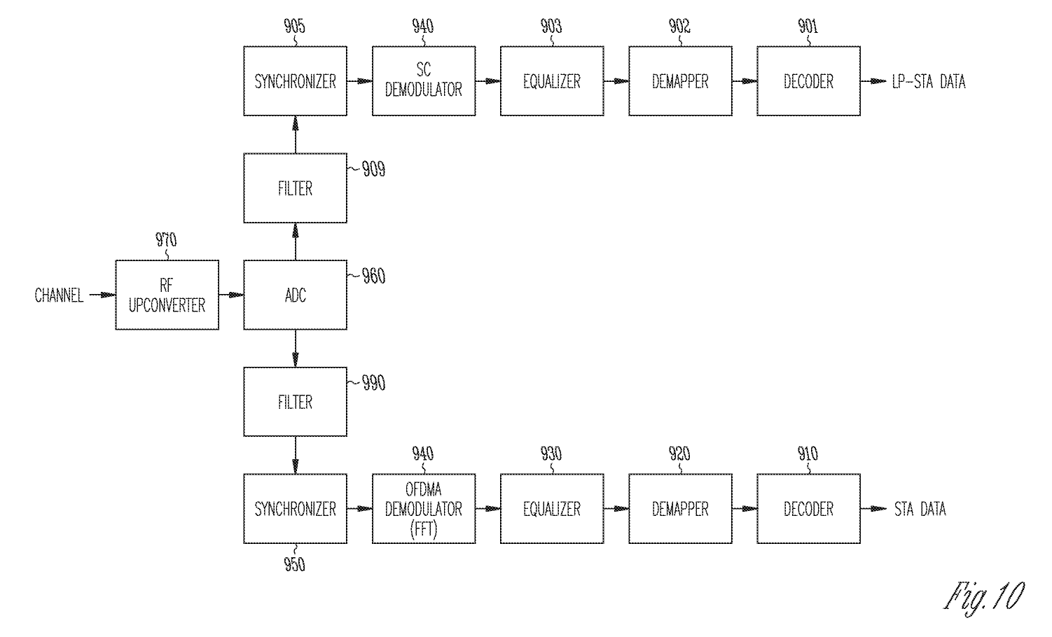

FIG. 9 shows components for transmitting data to STAs via OFDMA and to LP-STAs via the SC waveform according to another embodiment. The components for forming the baseband SC and OFDMA waveforms are the same as described with respect to FIG. 8. In this embodiment, however, each of the baseband SC and OFDMA waveforms are converted to analog by an ADC 860 before being added to form the composite waveform. A notch filter 880 may be applied to the OFDMA waveform after conversion to analogy to filter out those frequencies corresponding to the bandwidth and frequency location of the SC waveform.

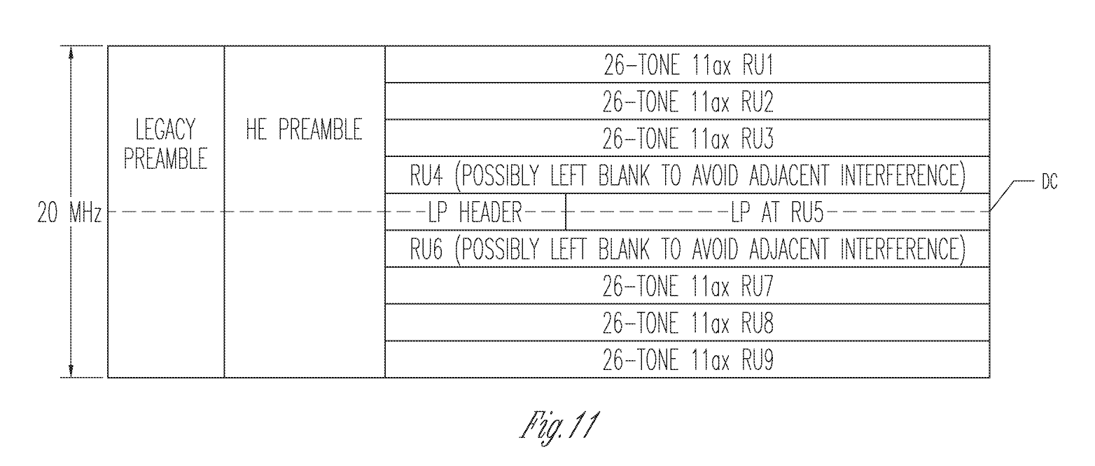

FIG. 10 shows components illustrates components for receiving both data from STAs via OFDMA and data from LP-STAs via the SC waveform according to one embodiment. A composite signal including both an SC waveform and an 802.11ax OFDMA waveform is downconverted to baseband by downconverter 970 and converted to digital by DAC 960. The resulting baseband composite waveform is then processed separately to extract the LP-STA and STA data therefrom. Filters 909 and 990 isolate the SC and OFDMA waveforms before such processing. Synchronizer 905 uses the LP preamble to synchronize subsequent processing by SC demodulator 904 that mixes the SC waveform with the SC frequency to extract the modulation symbols. Channel distortion is corrected for by equalizer 903. The modulation symbols are then demapped to bits by demapper 902 which are then decoded by decoder 901 to extract the LP-STA data. Synchronizer 950 uses the 802.11ax preamble to synchronize subsequent processing by OFDMA demodulator 940 (e.g., fast Fourier transform (FFT) followed by parallel-to-serial conversion) to extract the modulation symbols. Channel distortion is corrected for by equalizer 930. The modulation symbols are then demapped to bits by demapper 920 which are then decoded by decoder 910 to extract the STA data.

In some embodiments, the SC signal is multiplexed within non-central 802.11ax OFDMA allocations. In other embodiments, the central 26-tone allocation of 802.11ax OFDMA transmission is used for transmission of the low power SC signal, which has the advantage of providing a larger guard band regions between the 802.11ax and SC signals to help with multi-access interference (MAI) issues. Transmission of the SC waveform is scheduled along with 802.11ax OFDMA transmissions either in the DL or in the UL as a trigger-based uplink transmission. In the latter case, the LP preamble triggers an UL transmission of the SC waveform from the LP-STA using a previously defined frequency allocation, while the 802.11ax preamble triggers UL OFDMA transmissions from the STAs using RUs assigned to the STAs in the preamble. In some embodiments, the SC waveform is aligned with blocks of the OFDMA waveform, referred to as a block-wise single carrier (BWSC) waveform. In other embodiments, the SC waveform is not aligned or synchronized with the OFDMA waveform and may even use a different sampling or symbol rate.

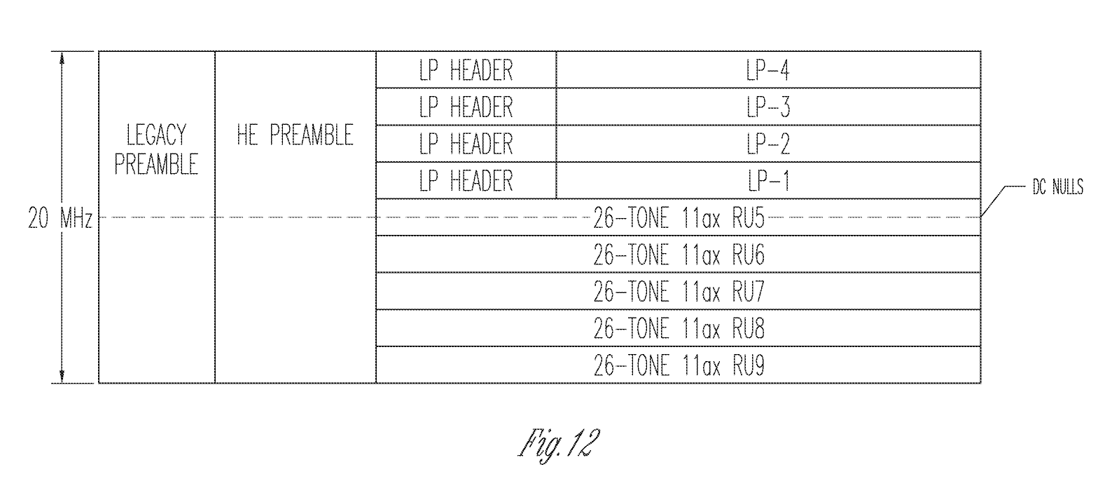

It should be noted that when all scheduled transmissions have the 802.11ax format, the MAI is controlled and limited through properties of OFDMA (assuming that they are frequency and time synchronized). However, when there is a mix of LP SC and 802.11ax waveforms, the performance of LP receivers may suffer from adjacent 802.11ax interference, and similarly the performance of 11ax receivers may degrade due to adjacent interference due to the LP waveform. Two example cases are discussed below. For both examples, the LP SC waveform is a BWSC waveform and is placed at the central RU location RU 5 as illustrated by FIG. 11. The rest of RUs (1, 2, 3, 4), and (6, 7, 8, 9) are assigned to 802.11ax users. The scheduler can choose to leave RUs 4 and 6 empty to provide additional guard bands between 801.11ax users and the LP SC waveform at the central allocation as shown in FIG. 11.

In a first example, each block of the SC waveform is aligned to one 802.11ax OFDM symbol with a 16 usec duration (12.8 usec of data+3.2 usec of CP). For this example, 16 symbols for modulated data and 4 symbols for CP are considered so that the sampling period T_sampling=[16 usec/20 (modulation symbols+CP)]=0.8 usec. With BPSK modulation, the channel rate is 1.25 Mbps, and the bit rate is 1 Mbps. The information bit rate with a rate 1/2 coding is then 500 Kbit/sec. Assuming a rolloff factor beta of 10%, the bandwidth BW of the SC waveform is then:

BW=(1+beta)/T_sampling=1.1/0.8 usec=1.375 MHz

The available bandwidth: (26-tone RU+5 DC nulls) 20 MHz/256 (FFT)=2.421875 MHz There will thus be (2.421875−1.375)/2=523.5 KHz of guard band on each side to the nearest 11ax RU. This is almost equivalent to seven 11ax subcarriers on each side.

In a second example, each block of the SC waveform is aligned to one 802.11ax OFDM symbol with a 16 usec duration (12.8 usec of data+3.2 usec of CP). For this example, 28 symbols for modulated data and 3 symbols for CP are considered so that the sampling period T_sampling=[12.8 usec/28(modulation symbols]=0.457 usec. The information bit rate with a rate 1/2 coding is then 1.09375 Kbit/sec. Assuming a rolloff factor beta of 10%, the bandwidth BW of the SC waveform is then:

BW=(1+beta)/T_sampling=1.1/0.8 usec=2.40625 MHz

The available bandwidth: (26-tone RU+5 DC nulls) 20 MHz/256 (FFT)=2.421875 MHz. There will thus be (2.421875−2.40625)/2=7.8125 KHz of guard band on each side to the nearest 11ax RU. This is almost equivalent to 1/10 of the 802.11ax subcarriers spacing.

The two waveform examples, at 1.375 MHz and 2.40625 MHz, illustrate two extreme cases where there is either a very small or a very large guard band between the LP SC waveform at the center 26-tone RU and the nearest 802.11ax RU's. Also, in these examples, it is assumed that the symbol duration of the SC waveform is equal to the OFDMA symbol duration. In general, symbol durations of the SC and OFDMA waveforms can be different. Moreover, the SC sand OFDM signals may be asynchronous and may have different sampling frequencies. In one embodiment, however, the SC and OFDMA waveforms have the same symbol durations and/or synchronous frames to make practical scheduling easier.

When 802.11ax devices have robust modulation such as BPSK modulation with rate 1/2 coding, even the large bandwidth transmission of an LP SC waveform has negligible impact on the performance of the 802.11ax receivers. But as the bandwidth of the LP SC waveform increases; leaving less guard band to 11ax devices, using a higher modulation and coding scheme (MCS) results in some performance degradation. In the latter case, The AP scheduler can leave the 802.11ax allocations adjacent to the LP SC waveform unoccupied as shown in FIG. 11. The performance of LP-STA receiver at RU5, when other RUs are allocated to 802.11ax users and when the bandwidth of the LP SC signal is large, degrades due to adjacent interference from the 802.11ax users. In this case, the AP scheduler can leave the adjacent RUs unscheduled to mitigate this interference.

FIG. 12 shows another embodiment in which multiple LP SC signals are multiplexed within non-central 802.11ax OFDMA allocations. As shown in the figure, four LP SC waveforms LP-1 through LP-4 are shown as allocated to consecutive RU locations. If needed, the 802.11ax allocation at RU5 may be left blank to mitigate interference.

### Additional Notes and Examples

In Example 1, an apparatus for a wireless access point (AP) or station (STA) comprises: memory and processing circuitry, wherein the processing circuitry is to: generate a single-carrier (SC) waveform that comprises a baseband carrier frequency modulated by data to be transmitted to a low-power station (LP-STA); generate an orthogonal frequency division multiple access (OFDMA) waveform that includes data to be transmitted to one or more wireless stations (STAs) wherein the data for each of the one or more STAs is carried by one or more allocated resource units (RUs), each RU comprising a group of contiguous OFDMA subcarriers; and, frequency multiplex the SC and OFDMA waveforms, wherein the SC waveform has a bandwidth corresponding to one or more RUs within the OFDMA waveform. The SC and OFDMA waveforms may be frequency mulitplexed by adding them either in the digital domain or the analog domain.

In Example 2, the subject matter of any the Examples herein may optionally include wherein the processing circuitry is to null subcarriers of the OFDMA waveform that are within a specified bandwidth on either side of the baseband carrier frequency of the SC waveform.

In Example 3, the subject matter of any the Examples herein may optionally include wherein the processing circuitry is to: encode a trigger frame to request uplink transmissions from the LP-STA and from one or more STAs, the trigger frame indicating which RUs are allocated to each of the one or more STAs for its uplink transmission; receive a composite baseband waveform in response to the trigger frame that comprises an SC waveform added to an OFDMA waveform; OFDMA demodulate the composite baseband waveform to extract data carried by subcarriers of the OFDMA waveform, discard subcarriers of the OFDMA waveform within a specified bandwidth on either side of the baseband carrier frequency of the SC, and recover data transmitted from the one or more STAs; and, filter the composite baseband waveform to extract the SC waveform therefrom and demodulate the SC waveform to recover data transmitted from the LP-STA.

In Example 4, the subject matter of any the Examples herein may optionally include wherein the OFDMA waveform is a physical layer packet that includes an OFDMA preamble followed by an OFDMA data field and wherein the SC waveform is a physical layer packet that includes a low-power (LP) preamble followed by an SC data field.

In Example 5, the subject matter of any the Examples herein may optionally include wherein the OFDMA preamble is an 802.11ax preamble that spans a system bandwidth of 20 MHz or greater and the LP preamble spans a bandwidth equal to the bandwidth of the SC data field.

In Example 6, the subject matter of any the Examples herein may optionally include wherein the OFDMA preamble is an 802.11ax preamble that, for downlink transmissions to STAs, has a field carrying RU allocations for the STAs.

In Example 7, the subject matter of any the Examples herein may optionally include wherein the processing circuitry is to convert the SC and OFDMA waveforms to analog form before adding them.

In Example 8, the subject matter of any the Examples herein may optionally include wherein the processing circuitry is to notch filter the OFDMA waveform to remove frequencies corresponding to the bandwidth of the SC waveform.

In Example 9, the subject matter of any the Examples herein may optionally include wherein the digital SC and OFDMA waveforms have different sampling rates.

In Example 10, the subject matter of any the Examples herein may optionally include wherein the processing circuitry is to add a cyclic prefix to the SC waveform.

In Example 11, the subject matter of any the Examples herein may optionally include wherein the bandwidth of the SC waveform is centered about zero Hz and equal to the bandwidth of an RU.

In Example 12, the subject matter of any the Examples herein may optionally include wherein the SC waveform is a block-wise single-carrier (BWSC) waveform aligned with the RUs of OFDMA waveform.

In Example 13, the subject matter of any the Examples herein may optionally include a radio transceiver having one or more antennas, the radio transceiver connected to the processing circuitry and wherein the radio transceiver is to transmit the added OFDMA and SC waveforms.

In Example 14, an apparatus for a wireless access point (AP) or station (STA) comprises: memory and processing circuitry, wherein the processing circuitry is to: encode a trigger frame to request uplink transmissions from the LP-STA and from one or more STAs, the trigger frame indicating which RUs are allocated to each of the one or more STAs for its uplink transmission; receive a composite baseband waveform in response to the trigger frame that comprises an SC waveform added to an OFDMA waveform; OFDMA demodulate the composite baseband waveform to extract data carried by subcarriers of the OFDMA waveform, discard subcarriers of the OFDMA waveform within a specified bandwidth on either side of the baseband carrier frequency of the SC, and recover data transmitted from the one or more STAs; and, filter the composite baseband waveform to extract the SC waveform therefrom and demodulate the SC waveform to recover data transmitted from the LP-STA.

In Example 15, the subject matter of any the Examples herein may optionally include wherein the processing circuitry is to: generate a single-carrier (SC) waveform that comprises a baseband carrier frequency modulated by data to be transmitted to a low-power station (LP-STA); generate an orthogonal frequency division multiple access (OFDMA) waveform that includes data to be transmitted to one or more wireless stations (STAs) wherein the data for each of the one or more STAs is carried by one or more resource units (RUs) allocated to that STA, each RU comprising a group of contiguous OFDMA subcarriers; and, add the SC and OFDMA waveforms to frequency multiplex the SC and OFDMA waveforms, wherein the SC waveform has a bandwidth corresponding to one or more RUs within the OFDMA waveform.

In Example 16, the subject matter of any of the Examples herein may optionally include a radio transceiver having one or more antennas connected to the processing circuitry.

In Example 17, a computer-readable medium contains instructions to cause a wireless station (STA) or access point (AP), upon execution of the instructions by processing circuitry of the STA or AP, to perform any of the functions of the processing circuitry as recited by any of the Examples herein.

In Example 18, a method for operating a wireless station or access point comprises performing any of the functions of the processing circuitry and/or radio transceiver as recited by any of the Examples herein.

In Example 19, an apparatus for a wireless station or access point comprises means for performing any of the functions of the processing circuitry and/or radio transceiver as recited by any of the Examples herein.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect. An example LTE system includes a number of mobile stations, defined by the LTE specification as User Equipment (UE), communicating with a base station, defined by the LTE specifications as an eNodeB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11-2007 and/or 802.11(n) standards and/or proposed specifications for WLANs, although the scope of the disclosure is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the disclosure is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, release 8, March 2008, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus for a wireless access point (AP), the apparatus comprising:
memory and processing circuitry, wherein the processing circuitry is to:
generate a single-carrier (SC) waveform that comprises a baseband carrier frequency modulated by data to be transmitted to a low-power station (LP-STA);
generate an orthogonal frequency division multiple access (OFDMA) waveform that includes data to be transmitted to one or more wireless stations (STAs) wherein the data for each of the one or more STAs is carried by one or more allocated resource units (RUs), each RU comprising a group of contiguous OFDMA subcarriers; and,
frequency multiplex the SC and OFDMA waveforms, wherein the SC waveform has a bandwidth corresponding to one or more RUs within the OFDMA waveform.

2. The apparatus of claim 1 wherein the processing circuitry is to null subcarriers of the OFDMA waveform that are within a specified bandwidth on either side of the baseband carrier frequency of the SC waveform.

3. The apparatus of claim 1 wherein the processing circuitry is to:
encode a trigger frame to request uplink transmissions from the LP-STA and from one or more STAs, the trigger frame indicating which RUs are allocated to each of the one or more STAs for its uplink transmission;
receive a composite baseband waveform in response to the trigger frame that comprises an SC waveform added to an OFDMA waveform;
OFDMA demodulate the composite baseband waveform to extract data carried by subcarriers of the OFDMA waveform, discard subcarriers of the OFDMA waveform within a specified bandwidth on either side of the baseband carrier frequency of the SC, and recover data transmitted from the one or more STAs; and,
filter the composite baseband waveform to extract the SC waveform therefrom and demodulate the SC waveform to recover data transmitted from the LP-STA.

4. The apparatus of claim 1 wherein the OFDMA waveform is a physical layer packet that includes an OFDMA preamble followed by an OFDMA data field and wherein the SC waveform is a physical layer packet that includes a low-power (LP) preamble followed by an SC data field.

5. The apparatus of claim 4 wherein the OFDMA preamble is an 802.1ax preamble that spans a system bandwidth of 20 MHz or greater and wherein the LP preamble spans a bandwidth equal to the bandwidth of the SC data field.

6. The apparatus of claim 5 wherein the OFDMA preamble has a field carrying RU allocations for the one or more STAs to which data is to be transmitted.

7. The apparatus of claim 1 wherein the processing circuitry is to convert the SC and OFDMA waveforms to analog form before adding them.

8. The apparatus of claim 6 wherein the processing circuitry is to notch filter the OFDMA waveform to remove frequencies corresponding to the bandwidth of the SC waveform.

9. The apparatus of claim 6 wherein the digital SC and OFDMA waveforms have different sampling rates.

10. The apparatus of claim 1 wherein the bandwidth of the SC waveform is centered about zero Hz and equal to the bandwidth of an RU.

11. The apparatus of claim 1 wherein the SC waveform is a block-wise single-carrier (BWSC) waveform aligned with the RUs of OFDMA waveform.

12. The apparatus of claim 1 wherein the processing circuitry is to add a cyclic prefix to the SC waveform.

13. The apparatus of claim 1 further comprising a radio transceiver having one or more antennas, the radio transceiver connected to the processing circuitry and wherein the radio transceiver is to transmit the added OFDMA and SC waveforms.

14. A method for operating a wireless access point (AP), the apparatus comprising:
encoding a trigger frame to request uplink transmissions from the LP-STA and from one or more STAs, the trigger frame indicating which RUs are allocated to each of the one or more STAs for its uplink transmission;
receiving a composite baseband waveform in response to the trigger frame that comprises an SC waveform added to an OFDMA waveform;
OFDMA demodulating the composite baseband waveform to extract data carried by subcarriers of the OFDMA waveform, discarding subcarriers of the OFDMA waveform within a specified bandwidth on either side of the baseband carrier frequency of the SC, and recovering data transmitted from the one or more STAs; and,
filtering the composite baseband waveform to extract the SC waveform therefrom and demodulating the SC waveform to recover data transmitted from the LP-STA.

15. The method of claim 14 further comprising nulling subcarriers of the OFDMA waveform that are within a specified bandwidth on either side of the baseband carrier frequency of the SC waveform.

16. The method of claim 14 further comprising
generating a single-carrier (SC) waveform that comprises a baseband carrier frequency modulated by data to be transmitted to a low-power station (LP-STA);
generating an orthogonal frequency division multiple access (OFDMA) waveform that includes data to be transmitted to one or more wireless stations (STAs) wherein the data for each of the one or more STAs is carried by one or more allocated resource units (RUs), each RU comprising a group of contiguous OFDMA subcarriers; and,
frequency multiplexing the SC and OFDMA waveforms, wherein the SC waveform has a bandwidth corresponding to one or more RUs within the OFDMA waveform.

17. The method of claim 16 wherein the OFDMA waveform is a physical layer packet that includes an OFDMA preamble followed by an OFDMA data field and wherein the SC waveform is a physical layer packet that includes a low-power (LP) preamble followed by an SC data field.

18. The method of claim 17 wherein the OFDMA preamble is an 802.11ax preamble that spans a system bandwidth of 20 MHz or greater and the LP preamble spans a bandwidth equal to the bandwidth of the SC data field.

19. The method of claim 16 further comprising converting the SC and OFDMA waveforms to analog form before adding them.

20. The method of claim 19 further comprising notch filtering the OFDMA waveform to remove frequencies corresponding to the bandwidth of the SC waveform.

21. A computer-readable medium comprising instructions to cause a wireless access point (AP), upon execution of the instructions by processing circuitry of the AP, to:
generate a single-carrier (SC) waveform that comprises a baseband carrier frequency modulated by data to be transmitted to a low-power station (LP-STA);
generate an orthogonal frequency division multiple access (OFDMA) waveform that includes data to be transmitted to one or more wireless stations (STAs) wherein the data for each of the one or more STAs is carried by one or more allocated resource units (RUs), each RU comprising a group of contiguous OFDMA subcarriers; and,
frequency multiplex the SC and OFDMA waveforms, wherein the SC waveform has a bandwidth corresponding to one or more RUs within the OFDMA waveform.

22. The medium of claim 21 further comprising instructions to null subcarriers of the OFDMA waveform that are within a specified bandwidth on either side of the baseband carrier frequency of the SC waveform.

23. The medium of claim 21 further comprising instructions to:
encode a trigger frame to request uplink transmissions from the LP-STA and from one or more STAs, the trigger frame indicating which RUs are allocated to each of the one or more STAs for its uplink transmission;
receive a composite baseband waveform in response to the trigger frame that comprises an SC waveform added to an OFDMA waveform;
OFDMA demodulate the composite baseband waveform to extract data carried by subcarriers of the OFDMA waveform, discard subcarriers of the OFDMA waveform within a specified bandwidth on either side of the baseband carrier frequency of the SC, and recover data transmitted from the one or more STAs; and,
filter the composite baseband waveform to extract the SC waveform therefrom and demodulate the SC waveform to recover data transmitted from the LP-STA.

24. The medium of claim 21 further comprising instructions to encode the OFDMA waveform as a physical layer packet that includes an OFDMA preamble followed by an OFDMA data field and encode the SC waveform as a physical layer packet that includes a low-power (LP) preamble followed by an SC data field.

25. The medium of claim 21 further comprising instructions to encode the OFDMA preamble as an 802.11ax preamble that spans a system bandwidth of 20 MHz or greater and encode the LP preamble to span a bandwidth equal to the bandwidth of the SC data field.
